(19) United States
(12) Patent Application Publication
(10) Pub. No.: US 2018/0265359 A1
(43) Pub. Date: Sep. 20, 2018

(54) ALLOTROPE OF CARBON HAVING INCREASED ELECTRON DELOCALIZATION

(71) Applicant: Structured Nano Carbon LLC, Pensacola, FL (US)

(72) Inventors: Danny CROSS, Pensacola, FL (US); Larry Herbert KIRBY, Lake Jackson, TX (US); Thomas Frank BAILEY, Lake Jackson, TX (US)

(21) Appl. No.: 15/925,650

(22) Filed: Mar. 19, 2018

Related U.S. Application Data
(60) Provisional application No. 62/490,500, filed on Apr. 26, 2017.
(60) Provisional application No. 62/473,152, filed on Mar. 17, 2017.

(51) Int. Cl. C01B 32/162; C01B 32/154; C08J 5/00; C01B 32/156; G01N 21/65; C01B 32/20; C01B 32/194; C01B 32/168

(52) U.S. Cl. CPC C01B 32/162; C01B 32/154; C08J 5/005; C01B 32/168; G01N 21/65; C01B 32/20; C01B 32/194; C01B 32/156

(57) ABSTRACT

Newly discovered allotrope of carbon having a multilayered nanocarbon array exhibits among other properties exceptional stability, electrical conductivity and electromagnetic frequency (emf) attenuation characteristics. Members of this new allotrope include nanocarbon structures possessing vast electron delocalization in multiple directions unavailable to known fullerene-characterized materials like carbon nano-onions (CNOs), multiwalled carbon nano-tubes (MWNTs), graphene, carbon nano-horns, and carbon nano-ellipsoids such that stabilizing electron delocalization crosses or proceeds between layers as well as along layers in multiple directions within a continuous cyclic structure having an advanced interlayer connectivity bonding system involving the whole carbon array apart from incidental defects.

### CROSS-REFERENCE TO RELATED APPLICATIONS

This Application claims the benefit of U.S. Provisional Application 62/473,152 filed on Mar. 17, 2017, and U.S. Provisional Application 62/490,500 filed on Apr. 26, 2017.

### BACKGROUND

### Field

Multilayered nanocarbon materials, such as previously known nanocarbon onions (NCOs) or carbon nano-onions (CNOs), onion-like carbons (OLCs), carbon nano-horns, multiwalled carbon nano-ellipsoids and carbon nanotubes (MWNTs) which are known examples of the fullerene allotrope wherein types of graphitic bonding describe the structure of individual layers.

### DESCRIPTION OF THE RELATED ART

Certain elements of the periodic table of chemistry exhibit allotropy¹ whereby pure elements present themselves in different forms as in arrangement of atoms in crystalline solids or in molecular forms that are differentiated on the basis of bearing different numbers and/or alignment and bonding of atoms that are generally manifested by different shapes and/or different physical and chemical properties. Allotropes may be monotropic, whereby one allotropic form is the most stable under all conditions, or they may be enantiotropic, whereby different forms are stable under different conditions and undergo reversible transitions from one to another at characteristic temperatures and pressures. ¹Encyclopedia Britannica on the Internet: https//www.britannica.com/science/allotropy 7-20-1998

Elements exhibiting allotropy include carbon, tin, sulfur, phosphorus, and oxygen. Tin and sulfur are enantiotropic whereby tin exists in a gray form, stable below 13.2° C., and a white form, stable at higher temperatures; sulfur forms rhombic crystals, stable below 95.5° C., and monoclinic crystals, stable between 95.5° C. and the melting point (119° C.). Phosphorus and oxygen are monotropic whereby red phosphorus is more stable than white phosphorus, and diatomic oxygen, having the formula O₂, is more stable than triatomic oxygen (ozone, O₃) under all ordinary conditions.

Before 1985, carbon was characterized as monotropic with graphite demonstrating greater stability over diamond under normal pressure and temperature and with no consideration given to a catch-all disorganized amorphous carbon. Today, the basis of these two allotropic carbons is connected to a difference in crystalline form that is tied to a different type of bonding between the carbons involved in the respective allotropes.

The diamond allotrope² possesses saturation in its bonding nature and exhibits a tetrahedron arrangement of carbon atoms bonded to one another head-to-head or head-on for maximum orbital overlap. Accordingly, a maximum bond-strength is achieved through sigma bonding only. Such strength is attributed to carbon atoms bearing a saturated bonding nature of a theorized three-dimensional hybridization of the one atomic s and three (x, y, and z) atomic p orbitals organized into a tetragonal bonding arrangement of the sp3 hybridized carbons wherein each carbon is perfectly separated at equidistance and equivalent tetrahedral bond angles of 109.47 degrees from every adjacent carbon and without the involvement of loose unaccounted-for electrons. ²Mark Weller, Tina Overton, Jonathan Rourke, Frazer Armstrong, Shriver & Atkins' Inorganic Chemistry, 5^{th} Edition, Chapter 14 (2014)

The graphite allotrope, on the other hand, possesses unsaturation in its bonding nature exhibiting a trigonal bonding arrangement associated with a theorized planar sp2 hybridization for each carbon in the system wherein each of three sp2 orbitals are bonded head-to-head or head-on with maximum orbital overlap and bond strength to one another through sigma bonding in planar fashion with each bond equidistant between respective bonded carbon atoms and oriented at 120 degree angles to one another. Left over from the sp2 hybridized bonding is a p orbital bearing an unpaired loose unaccounted-for electron that aligns with the p-orbitals left over from its adjacent sp2 carbon atom neighbors thereby allowing the maximum of tangential overlap for the otherwise loose electrons from each sp2 carbon thereby producing, through tangential overlap, pi bonds between respective carbon atoms which couple to other conjugated pi bonds to create a planar system of delocalized electrons with limits due only to the edges of the graphitic carbon planar structure or defects therein.

Without an understanding of the potential of conjugated pi bonds, one might expect that four strong sigma bonds would result in higher overall stability to just three strong sigma bonds with only the involvement of a weaker pi bond deriving from the electron of the separate p-orbital. In fact, the unconjugated pi bond is prone to reaction to convert the unsaturated sp2 to the saturated sp3 hybridization arrangement whereby all bonds become sigma. The pi bonds, however, have electrons involved with an ability to spread out over a whole system of connected pi bonds if the pi bonds are conjugated with one another. Such spreading out of electrons over a system of conjugated pi bonds creates a system of delocalized electrons that have been proven to yield a more stable overall system particularly in an endless cyclic arrangement. Accordingly, the trivalently bonded graphite allotrope with trigonally sigma bonded carbon atoms all in a plane is more thermodynamically stable than the quadrivalently bonded diamond allotrope with tetragonally sigma bonded carbon atoms.

Such differential bonding is the basis of explaining the otherwise unexpected stability to reactivity of benzene or aromatic materials as compared to isolated pi bonds and is characterized by the term “resonance stabilization” that accrues from a strong degree of electron delocalization arising from a complete loop and correspondingly exhibits electrical current equivalence over the six-membered ring without any interrupting insulation or discontinuity of a saturated sp3 carbon. Such a molecular current resembles macroscopic current in that benzene or aromatic rings exhibit delocalized electron currents demonstrable via nuclear magnetic fields associated with the resonance effects, thus characterized and utilized via the nuclear magnetic resonance (nmr) phenomenon. With the sp2 carbons involved having a planar arrangement, a useful way of viewing benzene is to think of there being a donut shaped cloud of pi delocalized electrons above and below the planar ring. Accordingly, aromatic systems exhibit substantially different properties as in reactivities being amenable to electrophilic substitution as opposed to the traditionally expected addition of isolated pi bonds.

With these underlying bonding considerations in mind, graphite which consists of multiple layers or sheets of fused benzene rings, one can see a remarkable degree of stabilization likened to “resonance stabilization” of benzene as result of the pi electrons, arising from the p orbitals from the sp2 hybridization of the carbon atoms involved in the structure, being delocalized molecularly over a planar sheet of interconnected and overlapping p-orbitals. Even though stronger molecular bonds between individual carbon atoms arise from the sigma bond due to its greater degree of head-on orbital overlap, the lesser degree of overlap of a tangential, non-head-on arrangement of adjacent p-orbitals results in forming the highly stabilizing pi electron cloud or network of electron delocalization with half the lobes of each p-orbital interacting above the plane of the graphite sheets and the other half below the plane as with the benzene delocalization through a donut cloud above and below its plane. With this in mind, the properties of graphite make sense with graphite being the more thermodynamically stable allotrope over diamond and also having a high degree of electrical conductivity through the corresponding electron delocalization throughout each plane. Additionally, tribological (lubricant) properties differ dramatically between graphite and diamond allotropes in that graphite bears only weak van der Waal forces between its only weakly interacting planes as opposed to actual complete sigma bonding crosslinking through sp3 hybridization of all layers of the diamond structure; therein the lubricity of graphite, perhaps involving intercalated impurities, stands in sharp contrast to the extreme abrasiveness of diamond surfaces.

In 1985³, Smalley, Curl and Kroto discovered buckminsterfullerene or “buckyball,” the first example of a nanocarbon allotrope bearing the name fullerene that shows correspondence to graphite because of the presence of electron delocalization capability. Fullerenes of generally larger sizes were subsequently discovered thereby leading to “buckyball” taking on the designation of C60 fullerene because of it bearing sixty carbons. Besides simple spheres possessing different carbon counts, the fullerene allotrope possesses a number of different general carbon structures of varying shapes generally described as bearing graphitic bonding. This fullerene allotrope is presented to include the following materials: nanocarbon onions (NCOs) or carbon nano-onions (CNOs), onion-like carbons (OLCs), carbon nano-horns, carbon nano-ellipsoids and multiwalled carbon nanotubes (MWNTs) as compared to singlewalled nantotubes (SWNTs) for example, even having graphene being considered by some in its realm due to its nanocarbon size and its graphitic bonding nature. ³Kroto H W, Heath J R, O'Brien S C, Curl R F, Smalley R E. C60: Buckminsterfullerene. Nature. 1985; 318 (6042): 162-3 doi: 10.1038/318162a0

As noted with graphite and also applicable to the single and multiple layer variations of graphene, electron delocalization is foundational to fullerene properties that is similar to but far from identical to the case of electron delocalization for individual sp2-hybridization in fused benzene ring components like naphthalene or anthracene. It is the curvature of fullerenes of structure that distinguishes fullerenes from planar systems like graphenes and graphite. This curvature dramatically alters the interaction of the p-orbital-like orbitals that might better be characterized as part of a sp2.3 or sp2.4 system or a highly strained sp2 system thereby yielding entirely different and unique properties from graphene or graphite systems of similar trigonally bonded carbons.

Also, unlike planar graphite that possesses the limitation to electron delocalization of edges, spherical fullerene molecules possess no edges, apart from defects in structure, arising from their cyclic structure with uninterrupted continuous delocalization through a kind of graphitic bonding system. Such a continuous cyclic arrangement compares to individual benzene in isolation with a cyclic delocalization above and below the six-membered ring but in a planar structure with equivalent bond lengths between the carbons in the aromatic ring.

With benzene, the electron delocalization is accompanied with an improvement of thermodynamic stabilization as noted according to measurable resonance stabilization with two contributing resonance structures wherein the double and single bonds are interchanged. This thermodynamic stabilization is demonstrated by comparing heats of hydrogenation for benzene versus cyclohexene or cyclohexadienes. The driving force for the existence of fullerenes can likewise be viewed to be attributed to electron delocalization with an even greater resonance stabilization possibility because of the plethora of possible three-dimensional resonance structures (12,500 for C60-fullerene), though somewhat impaired due to the strain of curvature that correspondingly reduces tangential overlap of p-orbitals of adjacent carbon atoms on the convex side of the curved surface due to the p-orbital-like orbitals diverging apart from one another at an angle⁴ which is compensated by the concave side's high degree of tangential overlap due to p-orbital-like orbitals converging towards one another and the center of the spherical structure. As a result of such strain resulting in the diverging radial orientation of the p-orbital-like orbitals on the exterior surface of the fullerene bearing free electrons, unlike with benzene with orthogonally aligned p-orbitals, the fullerenes should be susceptible to addition reactions likened to that for simple isolated (unconjugated) and unstrained olefins with orthogonally aligned p-orbitals for optimal tangential overlap. In contrast to such isolated pi bonds, benzene and other aromatic systems with associated disposable C—H (carbon-to-hydrogen) hydrogens seek to retain their resonance stabilization by disallowing addition reactions that would interrupt stabilizing electron delocalization and instead participate in electrophilic substitutions of one or more of the aromatic ring disposable hydrogens thereby allowing the reestablishment of the resonance stabilized aromatic system and its stabilizing electron delocalization over the six-membered ring. ⁴Mark Weller, Tina Overton, Jonathan Rourke, Frazer Armstrong, Shriver & Atkins' Inorganic Chemistry, 5^{th} Edition, Chapter 14 (2014) p388

For these prior fullerene allotropes, simple fullerene-like nanocarbon materials of the multilayer nature as of CNOs or NCOs, OLCs and MWNTs are explained generally to exist as sets of nested fullerene spheres or tubes or graphitic layers with each layer of resonance stabilization bonding being an isolated layer unto itself with only “van der Waal” attraction forces between layers similar to that of graphite or multilayered graphene but with the geometrical constraint of a continuous sphere as opposed to separating or displacing movement of layers of graphite or multilayer graphene. Each fullerene is described as having a similar nature to graphite particularly in that each carbon is bonded through sigma-like bonds to only three other carbons in the allotrope and displays a Raman spectroscopy peak similar to that of graphite or graphene, a strong G (“graphitic”) peak. Besides the similarity of respective delocalizations and fullerene and graphite or graphene attributes arising from trigonally substituted carbons with a free p-orbital or p-orbital-like orbital orthogonal to the other three sigma bonds, high resolution transmission electron micrographs (HRTEM) reveal layer separations of 0.34 nm for each. For the onion fullerene structures, publications generally report the number of layers varying between 5 and 30 depending on the method of synthesis.

### SUMMARY

A new allotrope of multilayered nanocarbon materials is herein introduced with an advanced bonding system of superior electron delocalization. Hitherto in the literature, the fullerene allotrope has been understood to encompass generally all trigonally bonded carbon systems of a curved nature and some would lump the nanocarbon graphene carbon materials into the fullerene category as well. Of particular focus of this invention is nanocarbon onions (NCOs) or carbon nano-onions (CNOs) or onion-like carbons (OLCs) wherein the systems possess a preponderance of generally complete continuous or cyclic layers without edges though some carbon nanotubes or graphenes with a high degree of multiple layers might harbor interest in regards to their possible relationship to this new allotrope, particularly if their edges could convert to a continuous cyclic system. The cavalier characterization of most all nanocarbons as being part of the fullerene family along with limitations of synthetic procedures of marginal yield and consistency in terms of numbers of layers and purity coupled to imprecise consideration of the bonding involved to be like that of graphite or graphene has been a severe stumbling block in the progression of the development of the nanocarbon technology since its inception in 1985 by Smally, Curl and Kroto with the discovery of the first fullerene molecule affectionately known as the Buckyball.

The new allotrope is formed through exposure of carbonaceous material, especially of multilayered nanocarbon materials particularly of the fullerene family and especially of spherical morphology, under carefully controlled residence times and temperature and pressure and atmosphere profiles compatible with what would generally be considered by others to be extreme conditions that should be avoided. Optimally the carbonaceous material is that of multilayered nanocarbon materials, particularly of the spherical fullerene family and especially of relatively low surface area produced at extreme conditions with high reproducibility and purity, without need for post-treatment with chemicals. Valued properties of the new allotrope are expected to improve dramatically with CNOs of greater number of layers. Due to the extreme conditions, the carbonaceous material undergoes a controlled disassembly and subsequent reassembly and rearrangement to a dramatically different bonding system of a far more thermodynamically stable allotrope. Spherical-like or spheroidal members, in contrast to tubular or planar analogs, possess a molecular formula of Cₓ where x ranges typically from about ten thousand to half a million and to two million to twenty million or more for more complex Cₓ structures resulting from catenation, for example, and a thousand times those numbers at the limits of the accepted nanocarbon range just below 100 nm in size.

Members of this new allotrope comprise multilayered nanocarbons that exhibit a dramatic difference in properties from members of the fullerene allotrope. Such properties, in part, are revealed in the realm of electrical conductivity, electromagnetic frequency (emf) attenuation, and thermal and oxidative stability.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 presents a Thermogravimetric Analysis comparison of a crossene allotrope sample to a fullerene allotrope sample.

FIG. 2 presents Raman Spectra comparing crossene allotrope samples to fullerene allotrope sample.

FIG. 3 presents an X-Ray Diffraction Pattern comparison of a crossene allotrope sample to a fullerene allotrope sample.

FIG. 4 presents electrical resistance data comparing a crossene allotrope to a fullerene allotrope.

FIG. 5A presents scanning electron micrograph (SEM) observations of a fullerene structure modified by catenation at 2500×.

FIG. 5B presents scanning electron micrograph (SEM) observations of a fullerene structure modified by catenation at 100,000×.

FIG. 5C presents high resolution transmission electron micrograph (HRTEM)observations of a fullerene structure modified by catenation at 150,000×.

FIG. 5D presents high resolution transmission electron micrograph (HRTEM) observations of a fullerene structure modified by catenation at 500,000×.

FIG. 5E presents high resolution transmission electron micrograph (HRTEM) observations of a crossene structure modified by catenation at 100,000×.

FIG. 5F presents high resolution transmission electron micrograph of the crossene structure of FIG. 5E with a contrasting background.

FIG. 5G presents high resolution transmission electron micrograph (HRTEM) observations of a crossene structure modified by catenation at 500,000×.

FIG. 5H presents high resolution transmission electron micrograph of the crossene structure of FIG. 5G with a contrasting background.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

A new allotrope of multilayered nanocarbon materials is herein introduced with an advanced bonding system of superior electron delocalization. Hitherto in the literature, the fullerene allotrope has been understood to encompass generally all trigonally bonded carbon systems of a curved nature and some would lump the planar nanocarbon graphene carbon materials into the fullerene category as well. Of particular focus of this invention is nanocarbon onions (NCOs) or carbon nano-onions (CNOs) or onion-like carbons (OLCs) wherein the systems possess a preponderance of generally complete continuous or cyclic layers without edges though some carbon nanotubes or graphenes with a high degree of multiple layers might harbor interest in regards to their possible relationship to this new allotrope, particularly if their edges could convert to a continuous cyclic system. The imprecise characterization of most all nanocarbons as being part of the fullerene family along with limitations of synthetic procedures of marginal yield and consistency in terms of numbers of layers and purity coupled to an unsophisticated consideration of the bonding involved to be like that of graphite or graphene has been a severe stumbling block in the progression of the development of the nanocarbon technology since its inception in 1985 by Smally, Curl and Kroto with the discovery of the first fullerene molecule routinely referred to as the C60 fullerene or Buckyball.

The new allotrope is formed through exposure of carbonaceous material, especially of multilayered nanocarbon materials particularly of the fullerene family, under carefully controlled residence times and temperature and pressure and atmospheric profiles compatible with what would be considered extreme conditions, generally above 2000° C. and optimally at 2600° C. to 2800° C. and above in annealing gases not necessarily restricted to inert gases like argon or nitrogen alone but optimally including small amounts of reactive gases as from the halogen family like chlorine. Such extreme conditions are required to convert the completed spherical layering with a central C60 fullerene core or nucleus of the CNO fullerene to the new allotrope that no longer has a core but rather a hole or void generally between 3 and 9 nm depending on the degree of layering and therein generates stretches of planar carbon between points of curvature. Optimally the carbonaceous material precursor to the newly recognized allotrope is that of multilayered nanocarbon materials, particularly of the spherical fullerene family especially of relatively low surface area produced with low polydispersity in size and layering, high consistency, high reproducibility and high purity, without need for post-treatment with chemicals. Valued properties of the new allotrope are expected to improve dramatically with precursor CNOs of greater number of layers.

Due to the extreme conditions, the carbonaceous material undergoes a controlled disassembly and subsequent reassembly and rearrangement to a dramatically different bonding system of a far more thermodynamically stable allotrope. Spherical-like members, as opposed to incompletely continuous tubular or planar analogs bearing edges, possess a molecular formula of Cx where x ranges typically from about ten thousand to half a million and to two million to twenty million or more for more complex structures resulting from catenation for example.

Members of this new allotrope comprise multilayered nanocarbons that exhibit a dramatic difference in properties from members of the fullerene allotrope. Such properties, in part, are revealed in the realm of electrical conductivity, electromagnetic frequency (emf) reception/attenuation/transformation, and thermal and oxidative stability.

A whole new bonding structure, unaccommodatable by the simple fullerene concept of concentric layers of graphitic structures, connects one layer of this new allotrope to another in multilayered nanocarbon systems analogous to onions (CNOs or OLCs) or cylinders or tubes (MWNTs) but in a completely new arrangement in the array of carbons associated with the nanocarbon material. Multilayered or nested fullerene allotropic materials possess individual covalently connected molecular concentric layers or shells that have the possible prospects of rotating individually independent of one another upon overcoming the anticipated generalized attractive forces between the layers or shells generally interpreted loosely as van der Waal forces as with graphite that has a layer separation also of 0.34 nm. With nested fullerenes, however, there is also the added limitation to free rotation in a curved system due to a special interiorly oriented attraction or pull likened unto gravity or magnetism to the center of the first layer or the C60 core or nucleus. This special interaction between layers derives from the exterior low electron density of a lower layer or shell to the interior high electron density of the subsequent concentric layer or shell. Consequently, more extreme conditions are required for the conversion of fullerene CNOs with greater degrees of layering. There is simply a greater need for energy in exploding the fullerene system with layering all the way to the C60 core or nucleus into a crossene system bearing long multilayered stretches of general planarity and a hole or void three to nine times that of the volume of the 1 nm C60 fullerene core due to the ever greater thermodynamic stability with increases in layering.

Unlike the nested fullerene system, the new allotrope possesses a fixed arrangement or orientation of the inner shells with the outer shells held in place by the continuous multilayered system through points of curvature serving as a kind of window frame for holding the long stretches of planar areas in place in their optimal electron delocalization orientation between layers. The window frame is not in a generalized planar two-dimensional form customarily but routinely involves a ribbon-like structure that protrudes or worms into a three dimensional kind of ball array of multilayered trigonally bonded carbons. Accordingly, the new allotrope is one complete molecule without any movement or sliding between the layers or shells with respect to one another that is customarily facilely available with multilayered systems such as graphite.

Electron delocalization proceeds then in one perspective not only along individual layers or surfaces alone particularly in the long stretches of multilayered planarity as with aromatic-like systems like graphite but also through the points of curvature through the interiorly directed or focused fullerene-like electron delocalization. The other perspective for electron delocalization is not just along the layers or surfaces but throughout the whole single molecule of the new allotrope volumetrically or three-dimensionally across layers as well. This new allotrope therefore is separate from fullerenes through a continuity of bonding and electron delocalization extending beyond the dimension of just individual layers or surfaces within fullerenes to a new, three-dimensional crosslinking bonding network or array that supersedes the less inter-engaged fullerene layer system. This new understanding in allotrope bonding systems carries over to systems that are doped such as with silicon, boron, nitrogen, oxygen, sulfur and phosphorous introduced in any number of ways including carbon fragments, units or moieties involving heteroatoms.

This new allotrope is given the new name of “crossene” denoting its dramatic difference from a fullerene that takes into account the crossing of electron delocalization between layers as well as along layers. The crossene name also appears appropriate because it is a kind of cross between graphenic layers in the long stretches of plains of graphitic material that are held in place by fullerene-like points of curvature serving as a kind of window frame for planar panes of graphitic material. The orientation of the graphenic material in the long stretches of graphitic planes is expected to be held rigidly in place in a “AAA . . . ” stacking arrangement for the optimal overlap of six-membered rings for achieving a kind of charge-transfer complex orientation that allows of the hopping of electrons between layers leading to the remarkable electron delocalization seen in crossenes responsible for achieving exceptional thermodynamic stability. Such unique volumetric delocalization thereby distinguishes crossenes from the far lower degree of electron delocalization of fullerenes and thereby accounts for exceptional degree of electron conductivity or emf attenuation for crossenes versus the corresponding multilayered fullerene allotrope.

This dramatic difference between the two allotropes is confirmed by a dramatically differently appearing Raman spectroscopy analysis where the GG or G′ peak dominates for the crossene allotrope while it is hardly noticeable with the fullerene allotrope. The crossene allotrope is also differentiated from the fullerene allotrope because of its exceptional thermodynamic stability exhibited in TGA (thermogravimetric analysis) versus that of the fullerene allotrope. In effect, the crossene allotrope is a special kind of multilayered graphene without edges forced into a stacking orientation that accentuates and multiplies electron conductivity and emf attenuation properties along with thermodynamic stability without toxicological concerns of the customary edges found in graphite and carbon nanotubes (CNTs) for example.

The C60 fullerene is prominent in intergalactic space and has been so for eons and was only recognized in 1985 by Smalley, Curl and Kroto. Only after their discovery of fullerenes, for which they were awarded the Nobel Prize, has the international nearly trillion dollar race been underway for further discovery, synthesis procedure development leading to eventual industrial production, modification techniques and application targets

As with fullerenes, crossenes have existed long before their present recognition described in this disclosure. With this disclosure, a similar race is anticipated. Fullerenes as well as crossenes have unknowingly been pursued since the days of Peter the Great of Russia who had recognized the healthful attributes of shungite, a mineral discovered near the city of Shunga' near St. Petersberg. This mineral site continues to serve as a spa of sorts since the days of Peter the Great. Also, especially since the 1985 discovery of C60 fullerene (Buckyball), the mineral of a mixture of many components is mined for export especially after it was revealed that it possessed fullerene components that recently were shown through C60 fullerene to have potential health benefits through initially designed toxicity testing in France on mice. Shungite appears through electron micrographs (HRTEM) to bear the crossene allotrope as well although they were never recognized or acknowledged as any kind of special nanocarbon material, especially as a separate allotrope of carbon.

Since the discovery of fullerenes and subsequently carbon nano-onions (CNOs) or nanocarbon onions (NCOs) or onion-like carbons (OLCs), there was no recognition made of this new crossene allotrope. This lapse persisted despite the discovery of the formation of so-called polyhedron nanocarbon material that was treated largely as a morphological curiosity with occasionally some recognition of some improvement of properties almost exclusively by spectroscopic examination as through Raman spectroscopy involving generally materials of relatively low layer number and low purity where both can conceal the true exceptional nature of the polyhedron curiosity where layering three times in number provides recognition far more dramatically which provides the basis of this patent declaring the new allotrope of crossene.

With almost 50 reported different synthetic routes to carbon nano-onions (CNOs), all of which involved uncontrolled reactions thus providing different carbon nano-onion material with each preparation in terms of the degree of layering, defects, catenation, polydispersity and side-reaction components, CNOs have received hardly any attention next to carbon nanotubes (CNTs) and graphene. Accordingly this new allotrope of carbon has been overlooked. With access to an abundance now of CNOs of high consistency in layer count and minimum of defects in high purity and of low polydispersity with essentially no side-reaction products, research into CNOs has proceeded well of late with now the announcement of a highly valuable new allotrope of crossene that is the most thermodynamically stable of the carbon allotropes next to fullerene and then graphite and graphene and finally diamond.

The reality of the differences between fullerenes and crossenes is demonstrated in the data provided in the Embodiments section. Accordingly properties and potential applications of this new allotrope exhibit a dramatic difference from fullerene allotropic materials due to a new bonding system resulting in differentiation in electron delocalization. This new kind of electron delocalization manifests itself in differently appearing Raman spectra of intensified G peaks and substantial GG or G′ peaks in great contrast to Raman spectra for simple fullerenes. In alignment with the given name for this new allotrope, one can consider the cross-over of pi-electron-like bonding between layers as a kind of cross-linking strengthening of the system that is borne out by its increase in thermogravimetric stability data. The crossene allotrope provides molecules of far greater thermodynamic stability than those of the fullerene allotrope family.

Discovery of the so-called “buckyball” or C60 fullerene molecule was facilitated due to its volatility upon intensive heating originally of a graphite anode wherein it was released under vacuum into a mass spectrometric vacuum chamber for analysis to display the telltale registered molecular weight of 720 a.m.u. The C60 fullerene subsequently was isolable and purifiable, particularly through High Pressure Liquid Chromatography (HPLC) due to its exhibited solubility as well.

The formation of crossenes has had no such advantages, being neither volatile nor soluble in the traditional sense. Only by way of a new synthetic procedure for generating selectively certain nanocarbon materials of exceptionally high multilayered nature, conversion, yield, consistency and purity could the new carbon allotrope's existence be discerned and thus recognized and reported finally as discovered. The foundation of this discovery is presented below based particularly upon the following characterization observables: thermodynamic stability, BET surface area, Raman spectroscopy, X-Ray diffraction evaluation, electrical conductivity, electromagnetic frequency (emf) attenuation, and scanning and transmission electron micrographs.

### I. Crossene Characterization

### A. Thermodynamic Stability

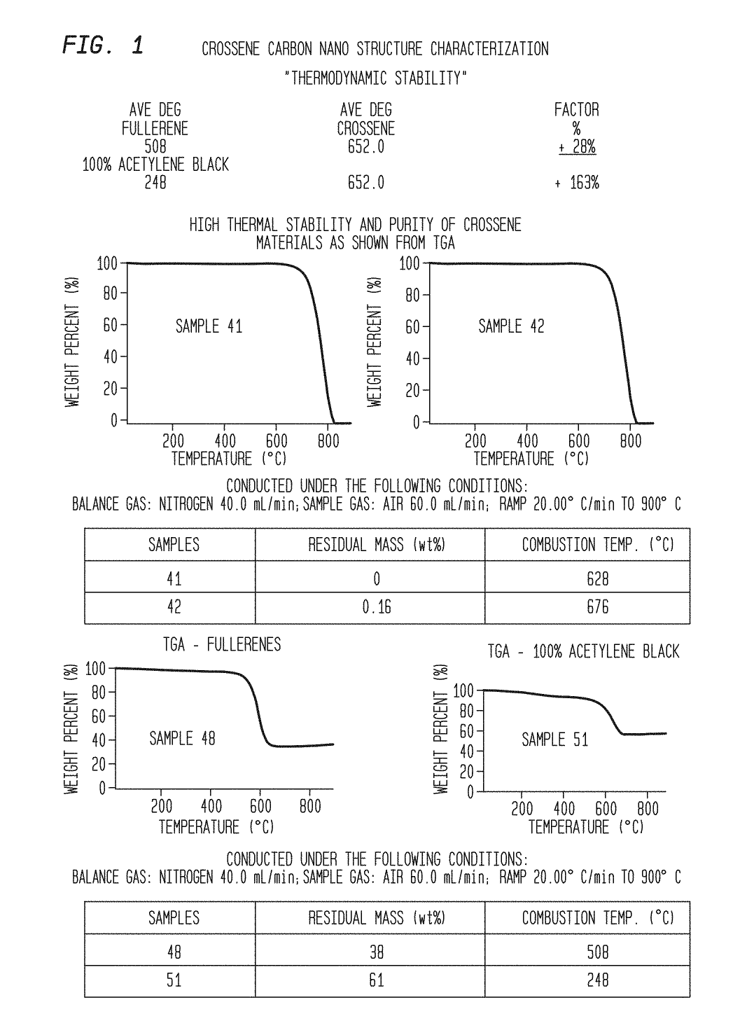

FIG. 1 presents a comparison of thermogravimetric analytical (TGA) data for a crossene allotrope versus a fullerene allotrope in the upper portion of the Figure and the lower portion respectively.

First and most dramatically the difference in thermodynamic stability of crossenes is plainly seen from its degree of combustion or oxidation resistance to an oxygen bearing gas at temperatures up to even 800° C. (See the upper portion of FIG. 1), well beyond the range of other graphitic structures like graphite or fullerenes whose resistance is rarely observed to proceed beyond 500° C. (See the lower portion of FIG. 1). The significantly enhanced thermodynamic stability would be expected to correlate to the level of electron delocalization of a crossene in comparison to a fullerene. The crossene's delocalization is not restricted to the individual nested fullerene layers of a multilayered nanocarbon system but involves the whole three dimensional system of the crossene molecule. FIG. 1 presents a comparison of thermogravimetric analytical (TGA) data for a crossene allotrope versus a fullerene allotrope. First and most dramatically the difference in thermodynamic stability of crossenes is plainly seen from its degree of combustion or oxidation resistance to an oxygen bearing gas at temperatures up to even 800° C. (See FIG. 1), well beyond the range of other graphitic structures like graphite or fullerenes whose resistance is rarely observed to proceed beyond 500° C. (See FIG. 1). The significantly enhanced thermodynamic stability would be expected to correlate to the level of electron delocalization of a crossene in comparison to a fullerene. The crossene's delocalization is not restricted to the individual nested fullerene layers of a multilayered nanocarbon system but involves the whole three dimensional system of the crossene molecule.

### B. BET Surface Analysis

Surface areas for crossene samples according to Brunauer-Emmett-Teller (BET) methods have routinely registered below 100 square meters per gram and more generally between 30 and 50 square meters per gram.

### C. Raman Spectroscopy

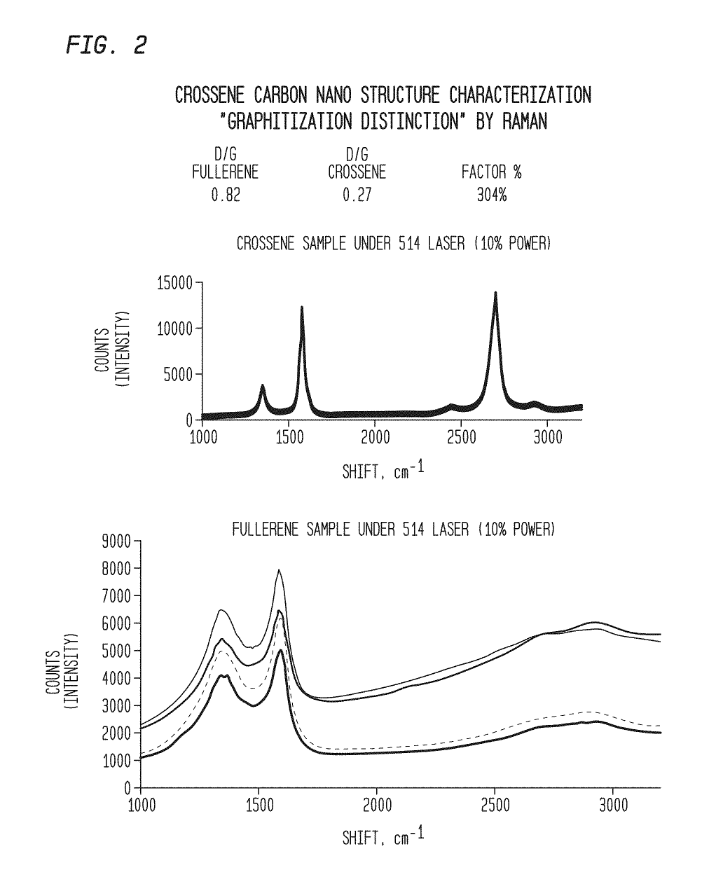

Raman spectroscopy has long been applied to fullerenes for distinguishing the degree of what is termed graphitization or electron delocalization between samples. Comparing the two sets of spectra performed on different spots of a crossene sample and a fullerene sample in FIG. 2, one sees a stark contrast between the Raman spectra of the crossene allotrope in the upper portion of the figure versus the fullerene allotrope of the lower portion of the figure, especially in the sharpness of the G (“graphitic”) signal and in the observation of a very strong and sharp GG signal that is hardly detectable at all in the amidst the signal noise with the fullerene allotrope. Such distinctions agree with at least an order and most likely several orders of magnitude difference in electron delocalization for crossenes versus fullerenes [See Section E on the conductivity/resistivity measurements. Using a Raman Renishaw Spectrometer employing a 514 nm laser at 10% power, a modest D peak occurs at roughly 1350 cm⁻¹ whereas the strong major G and GG peaks occur at 1575-1600 cm⁻¹ and 2695-2700cm⁻¹ respectively.

Raman spectroscopy has long been applied to fullerenes for distinguishing the degree of what is termed graphitization or electron delocalization between samples. Comparing the two sets of spectra performed on different spots on a crossing sample and a fullerene sample in FIG. 2, one sees a stark contrast between the Raman spectra of the crossene allotrope versus the fullerene allotrope, of the lower portion of the figure, especially in the sharpness of the G (“graphitic”) signal and in the observation of a very strong and sharp GG signal hardly indicated with the fullerene allotrope. Such distinctions agree with at least an order of magnitude difference in electron delocalization for crossenes versus fullerenes. Using a Raman Renishaw Spectrometer employing a 514 nm laser at 10% power, a modest D peak occurs at roughly 1350 cm⁻¹ whereas the strong major G and GG peaks occur at 1575-1600 cm⁻¹ and 2695-2700 cm⁻¹ respectively.

### D. X-Ray Diffraction

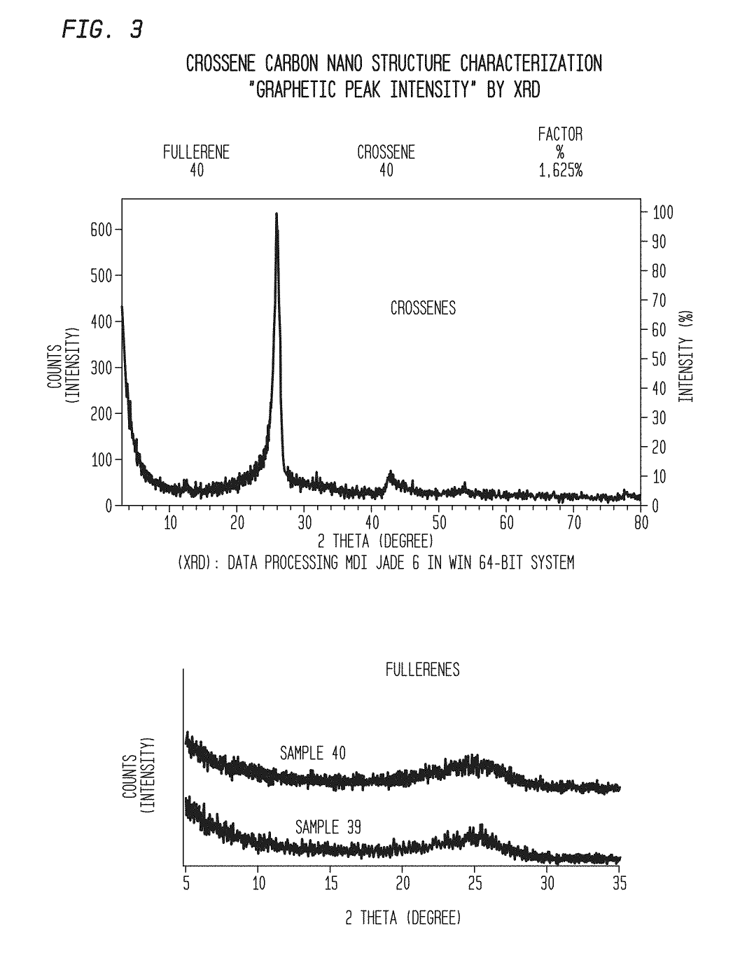

FIG. 3 corroborates the accentuated difference in the degree of delocalization demonstrated by way of Raman Spectroscopy in comparing a crossene allotrope in the upper portion of FIG. 3 to a fullerene allotrope in the lower portion of Figure.⁵ ⁵“Dependence of graphitic order of carbon nanostructures on AC and DC arc discharge methods and Ni content in thin electrode” C. R. JANG*, Gr. RUXANDA, M. STANCU, V. VOICU, D. CIUPARU** Petroleum—Gas University of Ploieşti, Bd. Bucureşti 39, 100680, Ploieşti, Romania, OPTOELECTRONICS AND ADVANCED MATERIALS—RAPID COMMUNICATIONS Vol. 6, No. 1-2, January-February 2012, p. 62-67 [file:///C:/Users/owner/Downloads/14Jang.pdf]

### E. Electrical Conductivity

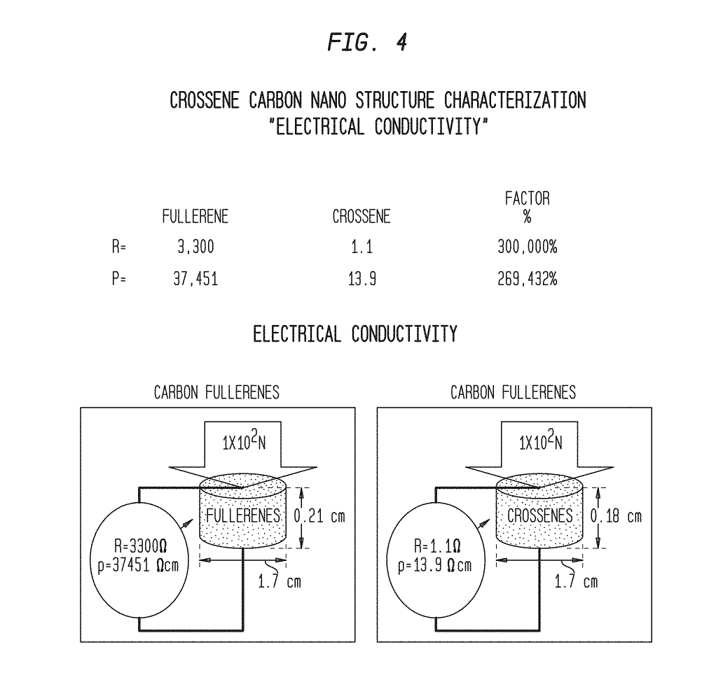

Just as the extent of electron delocalization is revealed in the TGA thermodynamic stability measurements of the crossene allotrope over the fullerene allotrope (as well the stark contrast in the Raman spectra of the crossene allotrope over the fullerene allotrope), the unique electron delocalization of crossenes over fullerene translates into an enhanced degree of electron conductivity capability of the crossene allotrope over the fullerene allotrope. FIG. 4 presents corresponding resistivity data of a crossene allotrope sample versus that of a fullerene allotrope sample. The calculated resistivity determined that the fullerene allotrope is much less conductive than the crossene allotrope by several orders of magnitude.

The degree of electron conductivity in the respective allotropes correlates to the degree of electron delocalization. When the whole system of delocalized electrons is a single molecule or three-dimensional or volumetric array of carbons as in crossenes, delocalization as reflected in thermodynamic and electrical conductivity is immensely superior to delocalization restricted to surface-only electron delocalization for the individual fullerene shells in multilayered nested fullerenes as with CNOs, OLCs or MWCTs. The dramatic difference in electrical conductivity and thermal stability is then readily understood between crossene and fullerene systems.

Just as the extent of electron delocalization determines the thermodynamic stability of the crossene allotrope over the fullerene allotrope, the unique electron delocalization of crossenes translates into an enhanced degree of electron conductivity capability of the crossene allotrope over the fullerene allotrope. FIG. 4 presents corresponding resistivity data of a crossene allotrope sample versus that of a fullerene allotrope sample. The calculated resistivity determined that the fullerene allotrope is much less conductive than the crossene allotrope.

The degree of electron conductivity in the respective allotropes correlates to the degree of electron delocalization. When the whole system of delocalized electrons is a single molecule or three-dimensional array of carbons as in crossenes, delocalization as reflected in thermodynamic and electrical conductivity is immensely superior to delocalization restricted to surface-only electron delocalization for the individual fullerene shells in multilayered nested fullerenes as with CNOs, OLCs or MWCTs. The dramatic difference in electrical conductivity and thermal stability is then readily understood between crossene and fullerene systems.

### F. Electromagnetic Frequency Attenuation

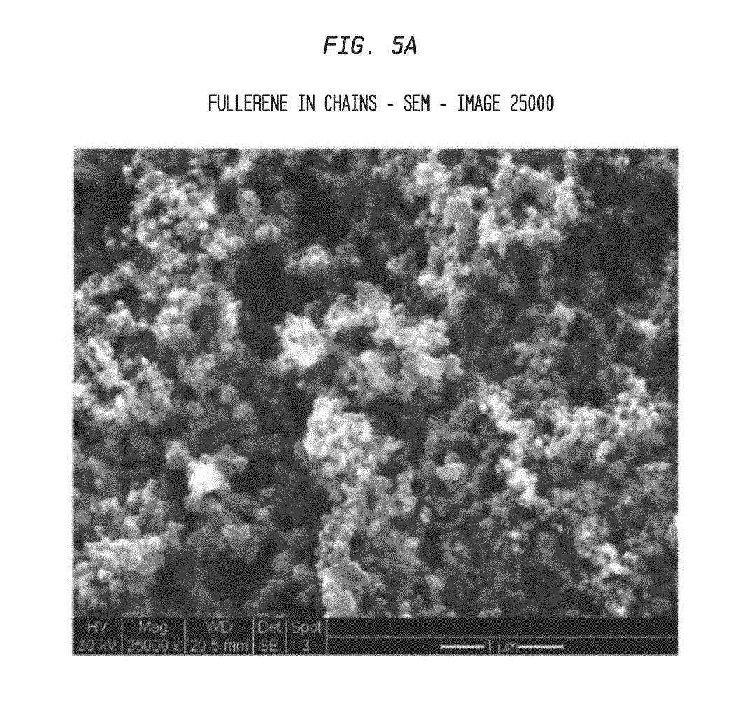

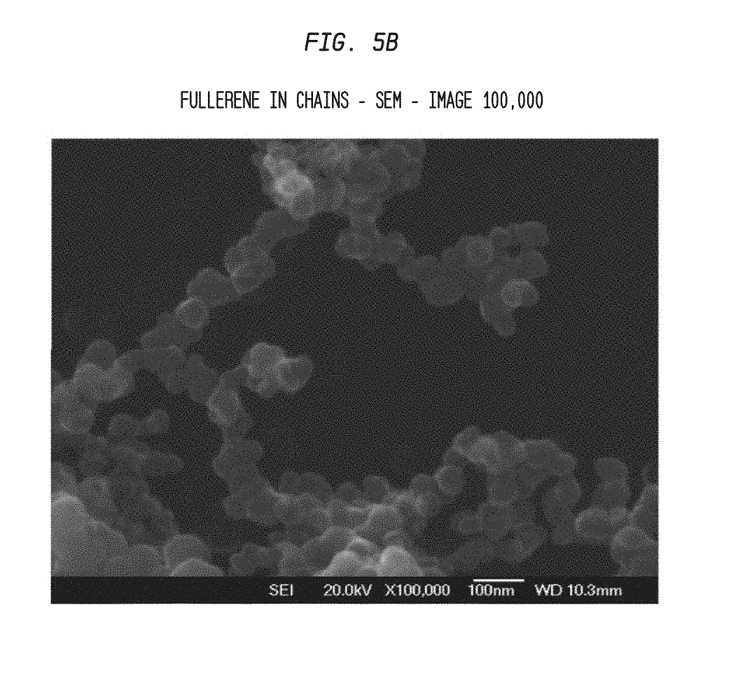

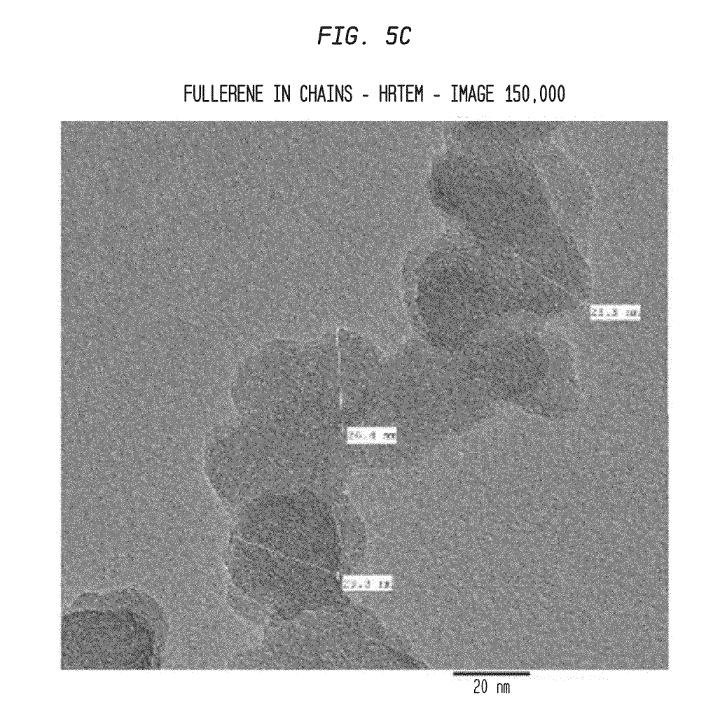

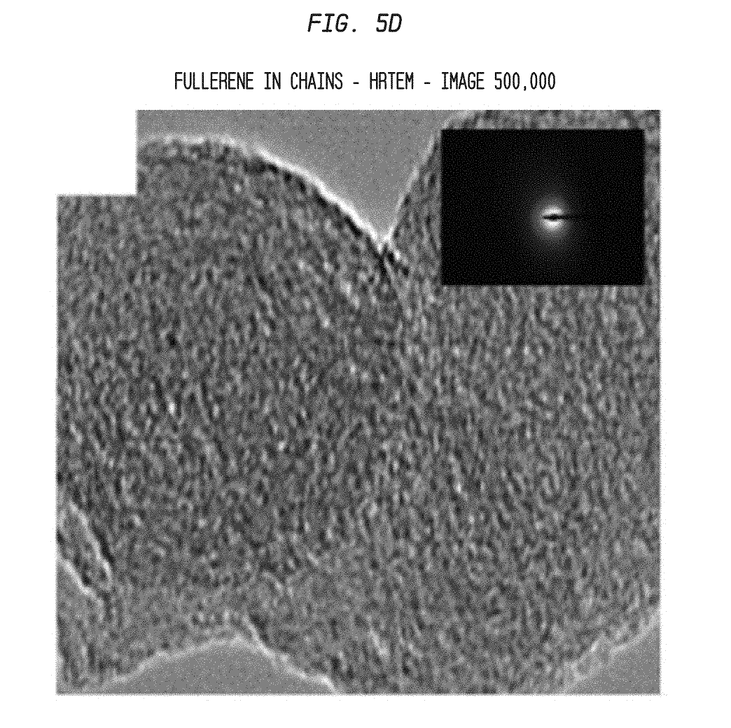

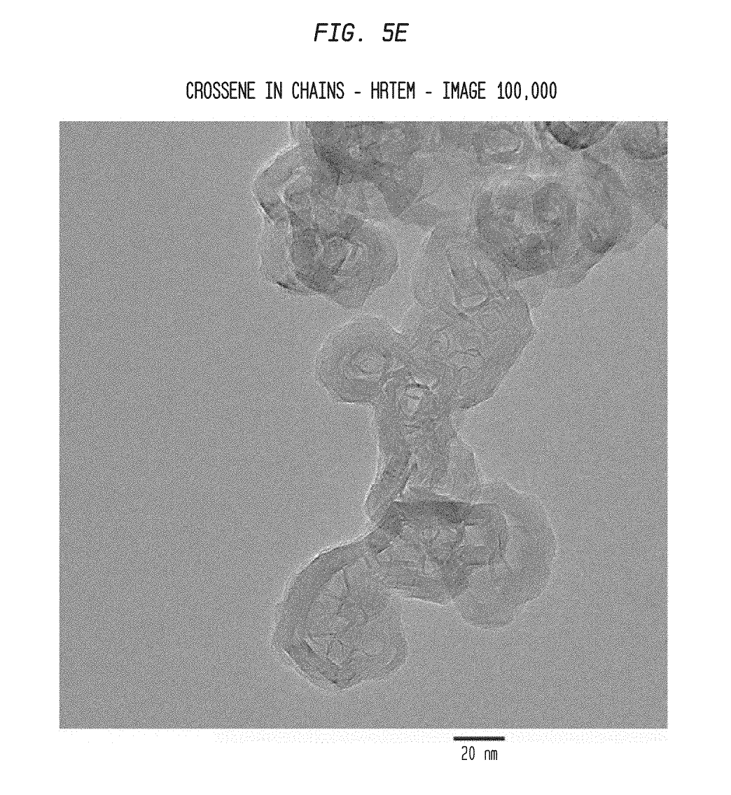

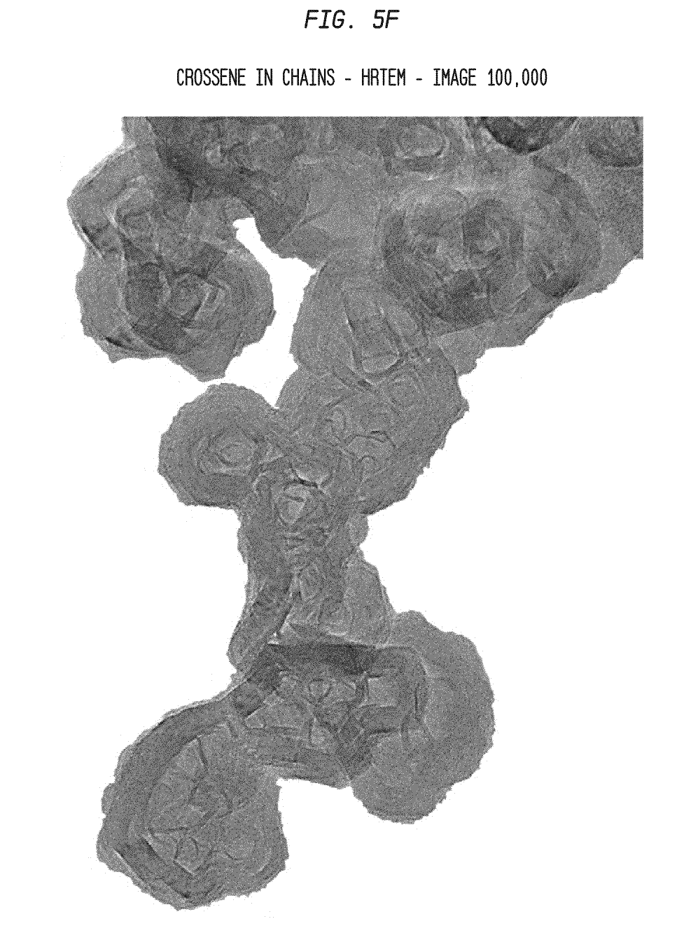

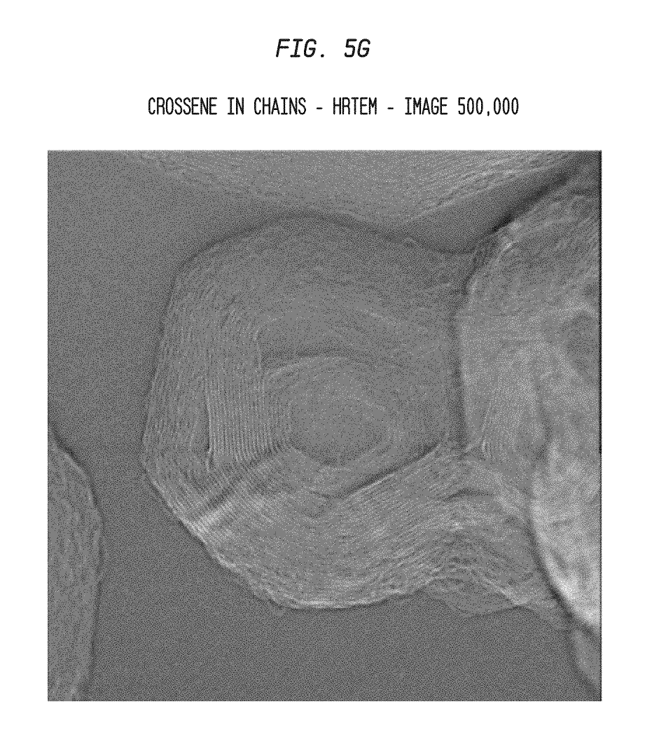

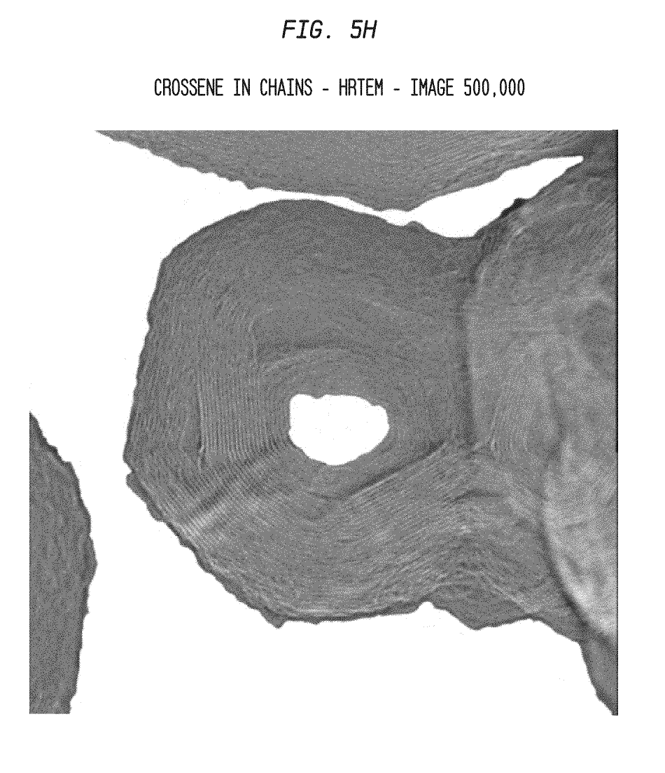

Another facet relating to electron delocalization is an extraordinary electromagnetic frequency (emf) attenuation effect. Such effect is observed for the fullerene allotrope especially of a multilayered or multiwalled nature such as the fullerene allotrope shown at different magnifications in FIGS. 5C and 5D. The effect is dramatically accentuated for the crossene allotrope by simple comparison of the fullerene allotrope of FIG. 5C and 5D versus the crossene allotrope of FIG. 5E and 5G in a household microwave oven. Both allotropes exhibit a metallic like sparking with the emission of light of a whole range of electromagnetic radiation appearing as a bright light along with thermal stimulation of the surrounding environment in just seconds as in the plate upon which the sample is placed upon exposure. Crossene samples, however, show a sharp contrast to that of fullerene samples in being blindingly bright white as compared generally to a subdued orangish light of fullerene samples. Correspondingly, the plate on which the sample is situated is heated up far more aggressively for crossene samples as opposed to fullerene samples where exposure of less than a second for a crossene sample far outmatches the thermal effect of the same exposure to a fullerene sample for over ten seconds.

Another facet relating to electron delocalization is an extraordinary electromagnetic frequency (emf) attenuation effect. Such effect is observed for the fullerene allotrope especially of a multilayered or multiwalled nature such as the fullerene allotrope shown at different magnifications in FIGS. 5A-5D. The effect is dramatically accentuated for the crossene allotrope by simple comparison of the fullerene allotrope of FIG. 5D versus the crossene allotrope of FIG. 5E in a household microwave oven. Both allotropes exhibit a metallic like sparking with the emission of light of a whole range of electromagnetic radiation appearing as a bright light along with thermal stimulation of the surrounding environment in just seconds as in the plate upon which the sample is placed upon exposure. Crossene samples, however, show a sharp contrast to that of fullerene samples in being blindingly bright white as compared generally to a subdued orangish light of fullerene samples. Correspondingly, the plate on which the sample is situated is heated up far more aggressively for crossene samples as opposed to fullerene samples where exposure of less than a second for a crossene sample far outmatches the thermal effect of the same exposure to a fullerene sample for over ten seconds.

### G. Scanning and Transmission Electron Micrographs

Micrograph comparisons are provided between samples of crossene and CNO fullerene of similar nature with both having a catenated structure. FIGS. 5A and 5B present fullerene SEM images at 25,000 and 100,000 magnification respectively. FIGS. 5C and 5D present fullerene HRTEM images at 150,000 and 500,000 magnification respectively. FIGS. 5E-5F and 5G-5H present crossene HRTEM images at 100,000 and 500,000 respectively. The catenated structure is apparent in the images of lower magnification while the high magnification images of FIG. 5D and FIG. 5G-5H reveal the drastic difference between the concentrically three-dimensional spherical CNO fullerene and the ribbon-like crossene with planar stretches surrounding a hole or void of varying dimensions and shapes and sizes where the layers are clearly visible and countable apart from overlapping crossene units in the catenated chain. With the high resolution images of fullerenes and crossenes, voids or holes of disparate sizes and shapes provides a dramatic differentiation between the fullerene allotrope and the crossene allotrope. The FIGS. 5E and 5G are the original micrographs for which FIGS. 5F and 5H are adjusted for improved contrast removing background material with a white background.

It is the requirement of extreme conditions that allows the conversion of a fullerene precursor with presumably a C60 core or nucleus to disassemble from its exceptionally thermodynamic status far greater than that of a C60 fullerene alone to reassemble to a yet dramatically more thermodynamically stable crossene with a far greater degree of delocalization not only associated with a particular layer but additionally across layers held in place through the continuous cyclic nature of the nano structure as a kind of window frame for optimizing electron delocalization across layers. The two distinct allotropes have up to now been lumped together mistakenly as different types of fullerene carbon nano-onions (CNOs).⁶ ⁶Tomita, S.; Sakurai, T.; Ohta, H.; Fujii, M.; Hayashi, S. J. Chem. Phys. 2001, 114, 7477-7482. doi: 10.1063/1.1360197

Micrograph comparisons are provided between samples of crossene and CNO fullerene of similar nature in having a catenated structure. FIGS. 5A and 5B present fullerene SEM images at 25,000 and 100,000 magnification respectively. FIGS. 5C and 5D present fullerene HRTEM images at 150,000 and 500,000 magnification respectively. FIGS. 5E and 5F present crossene HRTEM images at 100,000 and 500,000 respectively. The catenated structure is apparent in the images of lower magnification while the high magnification images of FIG. 5D and FIG. 5F reveal the drastic difference between the concentrically three-dimensional spherical CNO fullerene and the crossene with linear stretches where the layers can be clearly visible and counted. With the high resolution images of fullerenes and crossenes, voids or holes of disparate sizes and shapes provides a dramatic differentiation between the fullerene allotrope and the crossene allotrope.

It is the requirement of extreme conditions that allows the conversion of a fullerene precursor with presumably a C60 core or nucleus to disassemble from its exceptionally thermodynamic status far greater than that of a C60 fullerene alone to reassemble to a yet dramatically more thermodynamically stable crossene with a far greater degree of delocalization not only associated with a particular layer but additionally across layers held in place through the continuous cyclic nature of the nano structure as a kind of window frame for optimizing across layers. The two distinct allotropes have up to now been lumped together as different types of fullerene carbon nano-onions (CNOs).⁷ ⁷Tomita, S.; Sakurai, T.; Ohta, H.; Fujii, M.; Hayashi, S. J. Chem. Phys. 2001, 114, 7477-7482. doi: 10.1063/1.1360197

### II. Potential Crossene Surface Modifications

Known and presented in a recent review article⁸ is that C60 fullerene and fullerene onions have a reactive outer surface amenable to all manner of modification or, in nanocarbon-specific verbiage, of decoration that translates into all manner of means of functionalizing the surface for particular purposes and applications. Incidentally, as with the foregoing footnote, in the 2014 year of this review publication, what is now known as the crossene allotrope was identified as a fullerene “polyhedron onion.”⁸Bartelmess J, Giordani S. Carbon nano-onions (multi-layer fullerenes): Chemistry and applications. Beilstein J. Nanotechnol. 2014; 5: 1980-8; doi: 10.3762/bjnano.5.207

Known and presented in a recent review article⁹ is that C60 fullerene and fullerene onions have a reactive outer surface amenable to all manner of modification or, in nanocarbon-specific verbiage, of decoration that translates into all manner of means of functionalizing the surface for particular purposes and applications. Incidentally, as with the foregoing footnote, in the 2014 year of this review publication, what is now known as the crossene allotrope was identified as a fullerene “polyhedron onion.”⁹Bartelmess J, Giordani S. Carbon nano-onions (multi-layer fullerenes): Chemistry and applications. Beilstein J. Nanotechnol. 2014; 5: 1980-8; doi: 10.3762/bjnano.5.207

Though the exterior surface reactivity would be expected to be dramatically reduced from that of fullerenes, functionalization is expected to be achieved to some extent, especially at the points of curvature of the confining “window frame.” Additionally, functionalization may be first established in a fullerene CNO that may persist to some extent for certain functional groups following the conversion under extreme conditions to the crossene. Functionalization may be generated in a wide variety of known techniques including, but not limited to, 1,3 dipolar additions and other cycloadditions including carbene reactions, radical additions, halogenations, sulfonations, amidations, alkylations, and redox procedures.

Though the exterior surface reactivity would be expected to be dramatically reduced from that of fullerenes, functionalization is expected to be achieved to some extent, especially at the bends of the “window frame.” Additionally, functionalization may be first established in a fullerene CNO that may persist to some extent for certain functional groups following the conversion under extreme conditions to the crossene. Functionalization may be generated in a wide variety of known techniques including, but not limited to, 1,3 dipolar additions and other cycloadditions including carbene reactions, radical additions, halogenations, sulfonations, amidations, alkylations, and redox procedures.

Chemical modification may be applied to the outer surface to create a variety of different organic chemical functional groups to modify properties for rendering said carbon nanostructures amenable to various applications benefitting from the incorporation of organic functional groups for objectives in, but not limited to, adjusting solubilities in a variety of different solvents and compatibilities in polymerizations and solubilizations thereof in different media or in attachments of specialized agents useful, but not limited, to biological and medical applications, and also in enhancing prominent properties as in composite strengthening, electrical conductivity/storage, emf attenuation/reception, emf thermal stimulation, radiation curing enhancement, thermal insulation, biotechnology, biomedicine, preventive medicine, tribology, hydrophobicity, magnetism applications among others in regard to particular properties required for varied and diverse applications.

Chemical modification may be applied to the outer surface to create a variety of different organic chemical functional groups to modify properties for rendering said carbon nanostructures amenable to various applications benefitting from the incorporation of organic functional groups for objectives in, but not limited to, adjusting solubilities in a variety of different solvents and compatibilities in polymerizations and solubilizations thereof in different media or in attachments of specialized agents useful, but not limited, to biological and medical applications, and also in enhancing prominent properties as in composite strengthening, electrical conductivity/storage, emf attenuation/reception, thermal insulation, radiation curing enhancement, biotechnology, biomedicine, preventive medicine, tribology, hydrophobicity, magnetism applications among others in regard to particular properties required for varied and diverse applications.

Functionalization may proceed of the outer surface for example through potassium hydroxide or oxidation treatments as in treatment involving nitric acid, through addition or cycloaddition reactions, through simple fluoride or halogen addition reactions, through free radical addition reactions for preparing the nanoparticles for further functionalization as in sulfonation, and other means.¹⁰ ¹⁰Bhinge S D. Carbon nano-onions—An overview. J Pharm Chem Chem Sci. 2017; 1 (1): 1-2. J Pharm Chem Chem Sci 2017 Volume 1 Issue 1 [Editorial], Accepted on Oct. 13, 2017 http://www.alliedacademies.org/journal-pharmaceutical-chemistry-chemical-science/

Functionalization may proceed of the outer surface for example through potassium hydroxide or oxidation treatments as in treatment involving nitric acid, through addition or cycloaddition reactions, through simple fluoride or halogen addition reactions, through free radical addition reactions for preparing the nanoparticles for further functionalization as in sulfonation, and other means.¹¹ ¹¹ Bhinge S D. Carbon nano-onions—An overview. J Pharm Chem Chem Sci. 2017; 1 (1): 1-2. J Pharm Chem Chem Sci 2017 Volume 1 Issue 1 [Editorial], Accepted on Oct. 13, 2017 http://www.alliedacademies.org/journal-pharmaceutical-chemistry-chemical-science/

### III. Potential Crossene Applications

As can be readily seen from the Characterization and Modification sections, crossenes offer a wide range of applications regarding, but not limited to material science, metallurgical modifications as with alloy improvements with replacement of traditional carbon components and also covetics, aerospace, solar energy, 3D printing, polymers and plastics, polymer or plastic or inorganic composites or matrices, emf thermoset plastic curing, paints and coatings, oxidation/combustion resistance application, glass treatments, thermal insulation, electronics, electrical transmission, batteries or capacitors, emf attenuation/reception, catalysis, tribology, optical limiting, water resistance, cancer and dermatological treatments, preventive medicine, biological ablation therapy, emf-therapy, radiation protection, radiological contrasting agents including other bioimaging technologies, drug or gene agent delivery, toxin and heavy metal removal, and other biotechnology innovations.

Applications regarding material science, include, for example, engagement with polymer, plastic and/or inorganic composites or matrices and also thermoset formulations thereof as applied to, but not limited to the aerospace, 3D printing, electronics, construction/rehabilitation industries.

Applications regarding thermal insulation properties include, for example, refrigeration, clothing, housing, vehicles, shipping, aerospace, transportation, communication, industrial processes, electronics, paints and coatings, glass treatments, beverage and food service through the appropriate blending of the nanoparticles into the materials of interest directly or into the associated materials that render the thermal insulation properties.

Applications regarding electrical conductivity/storage properties include, for example, electrical conductivity/storage properties applied, but not limited, to electrical transmission, wiring, electronics, electrically motorized or hybrid vehicles, electrical motors, aerospace, mass transport, batteries and capacitors through incorporation of the nanoparticles into the appropriate carrier materials.

Applications regarding emf attenuation/reception properties include, for example, Faraday cage protection of people and electronics as in plastics, coating, paints, clothing, electronic device sheaths regarding wifi and smart meter protective devices in homes and vehicles and electronics from electromagnetic pulses in regards to cell phones, computers, automobile computers wherein the nanoparticles are blended into the materials of interest directly or into the associated materials that render the electromagnetic attenuation protection.

Applications regarding emf attenuation/reception properties include, for example, microwave oven use as in susceptor pads as in replacement of metal foil alternatives and to radiation-induced warming capability in clothing and/or equipment where especially high solar radiation is available in the midst of frigid temperatures.

Applications regarding emf attenuation/reception properties include, for example, enhancement of electromagnetic transmission reception equipment or techniques.

Applications regarding electromagnetic radiation attenuation/reception properties include, for example, to thermal stimulation in a multitude of ways particularly for use in polymers, plastics, paints, coatings and adhesives or solders for curing purposes by blending the nanoparticles into the materials of interest directly or into the associated materials that render the thermal stimulation properties.

Applications regarding tribological and/or thermal insulation properties include, for example, motor oils, lubes, cookware, associated coatings by blending the nanoparticles into the materials of interest directly or into the associated materials that render the tribological properties.

Applications regarding hydrophobicity properties include, for example, water resistance applications as in window and windshield fog elimination, weather-resistant material and clothing, biotechnological and biomedical pursuits, biomaterial encapsulation by blending the nanoparticles into the materials of interest directly or into the associated materials that render water resistant properties.

Applications regarding biotechnological and/or biomedical and/or preventive medicine utilization properties include, for example, selective tumor ablation due to radiation attenuation/thermal stimulation properties upon local administration of the nanoparticles followed by the application of highly directed microwave probes, antioxidant or photonic modulation effects for maintenance of living organism damage control effects by oral or injection nanoparticle procedures including use in acupuncture and related therapeutic regimens and also application topically especially for dermatological disorders including, but not limited to, moles and wounds.

Applications regarding biotechnological and/or biomedical utilization applied, but not limited, to bone scaffolding properties include, for example, 3D printing technology, x-ray or MRI contrasting agents, drug or gene delivery, and heavy metal removal.

Applications include, for example, material science, metallurgical modifications as with alloy improvements through replacement of traditional carbon components.

Applications include covetic alloy products produced in numerous manners generally during the production of nanocarbon materials.

Applications include use of crossene thermal stability properties for allowing these materials' utilization under high temperature conditions.

Applications include use of crossene thermal stability properties in biological studies where unconverted nanomaterial would survive combustion removal of biological matter for the purposes of tracking delivery of nanocarbon materials in biological systems.

Applications include of use any magnetic properties in biological systems as in specifically targeted therapy and bioimagery and other magnetism important applications.

Applications include use of crossene electromagnetic attenuation properties in regards to energy production especially in regards to solar energy issues.

The present invention includes item 1) a carbon allotrope bearing a multilayered three-dimensional nanocarbon array, wherein stabilizing electron delocalization crosses between layers in an advanced interlayer connectivity bonding system involving the whole carbon array; item 2) a carbon allotrope bearing a multilayered three-dimensional nanocarbon array, wherein stabilizing electron delocalization crosses between layers in an advanced interlayer connectivity bonding system involving the whole carbon array, wherein the electron delocalization proceeds between layers or surfaces and throughout the whole network of carbons in multiple directions in the carbon allotrope; and item 3) a carbon allotrope bearing a multilayered three-dimensional nanocarbon array, wherein stabilizing electron delocalization crosses between layers in an advanced interlayer connectivity bonding system involving the whole carbon array, wherein the carbon allotrope has exceptional properties in the realm.

The present invention further includes item 4) a carbon material, comprising a multilayered three-dimensional nanocarbon array, wherein stabilizing electron delocalization crosses between layers in an advanced interlayer connectivity bonding system involving the whole carbon array; item 5) a carbon material, comprising a multilayered three-dimensional nanocarbon array, wherein stabilizing electron delocalization crosses between layers in an advanced interlayer connectivity bonding system involving the whole carbon array, wherein the electron delocalization proceeds between layers or surfaces and throughout the whole network of carbons in multiple directions in the carbon array; item 6) a carbon material, comprising a multilayered three-dimensional nanocarbon array, wherein stabilizing electron delocalization crosses between layers in an advanced interlayer connectivity bonding system involving the whole carbon array, wherein the electron delocalization proceeds between layers or surfaces and throughout the whole network of carbons in multiple directions in the carbon array, wherein the nanocarbon material has exceptional properties in the realm; item 7) a carbon material, comprising a multilayered three-dimensional nanocarbon array, wherein stabilizing electron delocalization crosses between layers in an advanced interlayer connectivity bonding system involving the whole carbon array, wherein the electron delocalization proceeds between layers or surfaces and throughout the whole network of carbons in multiple directions in the carbon array, wherein the nanocarbon material has exceptional properties in the realm, wherein the nanocarbon material is derived from a carbon material produced from a process that has insignificant amounts of adverse side reaction contaminants otherwise requiring chemicals for purification; item 8) a carbon material, comprising a multilayered three-dimensional nanocarbon array, wherein stabilizing electron delocalization crosses between layers in an advanced interlayer connectivity bonding system involving the whole carbon array, wherein the electron delocalization proceeds between layers or surfaces and throughout the whole network of carbons in multiple directions in the carbon array, wherein the nanocarbon material has exceptional properties in the realm, wherein the carbon material from which the nanomaterial of item 6) is derived has a multilayered generally spherical or quasi-spherical form; item 9) a carbon material, comprising a multilayered three-dimensional nanocarbon array, wherein stabilizing electron delocalization crosses between layers in an advanced interlayer connectivity bonding system involving the whole carbon array, wherein the electron delocalization proceeds between layers or surfaces and throughout the whole network of carbons in multiple directions in the carbon array, wherein the nanocarbon material has exceptional properties in the realm, wherein the carbon material from which the nanomaterial of item 6) is derived and has a surface area below 100 square meters per gram as established by Brunauer-Emmett-Teller (BET) methods; and item 10) a carbon material, comprising a multilayered three-dimensional nanocarbon array, wherein stabilizing electron delocalization crosses between layers in an advanced interlayer connectivity bonding system involving the whole carbon array, wherein the electron delocalization proceeds between layers or surfaces and throughout the whole network of carbons in multiple directions in the carbon array, wherein the nanocarbon material has exceptional properties in the realm, and wherein the carbon material from which the nanomaterial of item 9) is derived and has a surface area between 30 and 50 square meters per gram as established by Brunauer-Emmett-Teller (BET) methods.

The present invention further includes item 11) the carbon allotrope or the carbon material of items 1)-10) bearing a multilayered three-dimensional nanocarbon array, wherein the material displays a minor peak near 1350 cm-1 using a Raman Renishaw Spectrometer employing a 514 nm laser at 10% power; item 12) the carbon allotrope or the carbon material of items 1)-10) bearing a multilayered three-dimensional nanocarbon array, wherein the material displays a minor peak near 1350 cm-1 using a Raman Renishaw Spectrometer employing a 514 nm laser at 10% power, wherein major peaks appear in the range of 1575 to 1600 cm-1 and of 2695 to 2700 cm-1 using a Raman Renishaw Spectrometer employing a 514 nm laser at 10% power; and item 13) the carbon allotrope or the carbon material of items 1)-10) bearing a multilayered three-dimensional nanocarbon array, wherein the material displays a minor peak near 1350 cm-1 using a Raman Renishaw Spectrometer employing a 514 nm laser at 10% power, wherein major peaks appear in the range of 1575 to 1600 cm-1 and of 2695 to 2700 cm-1 using a Raman Renishaw Spectrometer employing a 514 nm laser at 10% power, wherein stabilizing electron delocalization crosses between layers in an advanced interlayer connectivity bonding system involving the nanocarbon array.

The present invention further includes item 14) the carbon allotrope or the carbon material of items 1)-10), wherein the carbon material has a degree of combustion or oxidation resistance to an oxygen-bearing carbon allotrope or the gas at temperatures from 600 to 800 degrees Celsius; and item 15) the carbon allotrope or the carbon material of item 14), wherein stabilizing electron delocalization crosses between layers in an advanced interlayer connectivity bonding system involving the nanocarbon array.

The present invention further includes item 16) the carbon allotrope or the carbon material of items 1)-10) having a combustion temperature in air greater than 600 degrees Celsius; and item 17) the carbon allotrope or the carbon material of item 16), wherein stabilizing electron delocalization crosses between layers in an advanced interlayer connectivity bonding system involving the nanocarbon array.

The present invention further includes item 18) the carbon allotrope or the carbon material of items 1)-17), wherein individual crossene units are produced in oligomerized or polymerized states with properties thereby enhanced as in applications in composites and electrical conductivity for example;

The present invention further includes item 19) the carbon allotrope or the carbon material of items 1)-18), wherein heteroatoms or ensembles of heteroatoms like nitrogen, silicon, boron, phosphorous, sulfur and oxygen may be incorporated into the framework with minimal disruption of the electron delocalization but with the opportunity of inculcating the nanocarbon material with additional properties related to the nature of the heteroatom(s) incorporated; item 20) the carbon allotrope or the carbon material of items 1)-18), wherein nitrogen may be incorporated into the framework with minimal disruption of the electron delocalization but with the inculcation of additional properties specific to the nature of the incorporated nitrogen atom or ensembles of heteroatoms thereof; item 21) the carbon allotrope or the carbon material of items 1)-18), wherein silicon may be incorporated into the framework with minimal disruption of the electron delocalization but with the inculcation of additional properties specific to the nature of the incorporated silicon atom or ensembles of heteroatoms thereof; item 22) the carbon allotrope or the carbon material of items 1)-18), wherein boron may be incorporated into the framework with minimal disruption of the electron delocalization but with the inculcation of additional properties specific to the nature of the incorporated boron atom or ensembles of heteroatoms thereof; item 23) the carbon allotrope or the carbon material of items 1)-18), wherein phosphorous may be incorporated into the framework with minimal disruption of the electron delocalization but with the inculcation of additional properties specific to the nature of the incorporated phosphorous atom or ensembles of heteroatoms thereof; item 24) the carbon allotrope or the carbon material of items 1)-18), wherein sulfur may be incorporated into the framework with minimal disruption of the electron delocalization but with the inculcation of additional properties specific to the nature of the incorporated sulfur atom or ensembles of heteroatoms thereof; and item 25) the carbon allotrope or the carbon material of items 1)-18), wherein oxygen may be incorporated into the framework with minimal disruption of the electron delocalization but with the inculcation of additional properties specific to the nature of the incorporated oxygen atom or ensembles of heteroatoms thereof.

The present invention further includes item 26) the carbon allotrope or the carbon material of items 1)-18) and the modified material of items 19)-25), wherein functionalization is applied in a wide variety of known techniques including, but not limited to, 1,3 dipolar additions and other cycloadditions including carbene reactions, radical additions, fluorinations, alkylations, and redox procedures; item 27) the carbon allotrope or the carbon material of items 1)-18) and the modified material of items 19)-25), wherein chemical modification is applied to the outer surface to create a variety of different organic chemical functional groups to modify properties for rendering said carbon nanostructures amenable to various applications benefitting from the incorporation of organic functional groups for objectives in, but not limited to, adjusting solubilities in a variety of different solvents and compatibilities in polymerizations and solubilizations thereof in different media or in attachments of specialized agents useful, but not limited, to biological and medical applications, and also in enhancing prominent properties as in composite strengthening, electrical conductivity/storage, emf attenuation/reception, thermal insulation, radiation curing enhancement, biotechnology, biomedicine, preventive medicine, tribology, hydrophobicity, magnetism applications among others in regard to particular properties required for varied and diverse applications; item 28) the carbon allotrope or the carbon material of items 1)-18) and the modified material of items 19)-25), wherein functionalization through oxidation treatments of the outer surface as in treatment involving nitric acid for example prepares the nanoparticles for further functionalization particularly for the adjusting of properties of the nano particle(s) as in improving solubility capabilities in different solvents or in polymerization capabilities and otherwise for enhancing prominent properties as in composite strengthening, electrical conductivity/storage, emf attenuation/reception, thermal insulation, radiation curing enhancement, biotechnology, biomedicine, preventive medicine, tribology, hydrophobicity, magnetism applications among others in regard to particular property needs required for varied and diverse applications; item 29) the carbon allotrope or the carbon material of items 1)-18) and the modified material of items 19)-25), wherein functionalization through addition or cycloaddition reactions of the outer surface for example prepares the nanoparticles for further functionalization particularly for the adjusting of properties of the nanoparticle(s) as in improving solubility capabilities in different solvents or in polymerization capabilities and otherwise for enhancing prominent properties as in composite strengthening, electrical conductivity/storage, emf attenuation/reception, radiation curing enhancement, thermal insulation, biotechnology, biomedicine, preventive medicine, tribology, hydrophobicity, magnetism applications among others in regard to particular property needs required for varied and diverse applications; item 30) the carbon allotrope or the carbon material of items 1)-18) and the modified material of items 19)-25), wherein functionalization through simple halogen addition reactions of the outer surface for preparing the nanoparticles for further functionalization particularly for the adjusting of properties of the nano particle(s) as in improving solubility capabilities in different solvents or in polymerization capabilities and otherwise for enhancing prominent properties as in composite strengthening, electrical conductivity/storage, emf attenuation/reception, radiation curing enhancement, thermal insulation, biotechnology, biomedicine, preventive medicine, tribology, hydrophobicity, magnetism applications among others in regard to particular property needs required for varied and diverse applications; and item 31) the carbon allotrope or the carbon material of items 1)-18) and the modified material of items 19)-25), wherein functionalization through free radical addition reactions of the outer surface for preparing the nanoparticles for further functionalization as in sulfonation particularly for the adjusting of properties of the nano particle(s) as in improving solubility capabilities in different solvents or in polymerization capabilities and otherwise for enhancing properties as in composite strengthening, electrical conductivity/storage, emf attenuation/reception, radiation curing enhancement, thermal insulation, biotechnology, biomedicine, preventive medicine, tribology, hydrophobicity, magnetism applications among others in regard to particular property needs required for varied and diverse applications.

The present invention further provides item 32) applications of the carbon allotropes or the carbon materials of items 1)-18) and the modified material of items 19)-31) regarding, but not limited to material science, aerospace, 3D printing, polymers and plastics, emf thermoset plastic curing, thermal insulation, electronics, electrical transmission, emf attenuation/reception, catalysis, tribology, optical limiting, water resistance, cancer, preventive medicine, biological ablation therapy, emf-therapy, magnetic imagery, and other biotechnology innovations; item 33) applications of the carbon allotropes or the carbon materials of items 1)-18) and the modified material of items 19)-31) regarding material science applied, but not limited, to engagement with polymer, plastic and/or inorganic composites or matrices and also thermoset formulations thereof as applied to, but not limited to the aerospace, 3D printing, electronics, construction/rehabilitation industries; item 34) applications of the carbon allotropes or the carbon materials of items 1)-18) and the modified material of items 19)-31) regarding thermal insulation properties applied, but not limited, to refrigeration, clothing, housing, vehicles, shipping, aerospace, transportation, communication, industrial processes, electronics, paints and coatings, glass treatments, beverage and food service through the appropriate blending of the nanoparticles into the materials of interest directly or into the associated materials that render the thermal insulation properties; item 35) applications of the carbon allotropes or the carbon materials of items 1)-18) and the modified material of items 19)-31) regarding electrical conductivity/storage properties applied, but not limited, to electrical transmission, wiring, electronics, electrically motorized or hybrid vehicles, electrical motors, aerospace, mass transport, batteries and capacitors through incorporation of the nanoparticles into the appropriate carrier materials; item 36) applications of the carbon allotropes or the carbon materials of items 1)-18) and the modified material of items 19)-31) regarding emf attenuation/reception applied, but not limited, to Faraday cage protection of people as with plastics, coating, paints, clothing, electronic device sheaths, wifi and smart meter protective devices in homes and vehicles and electronics from electromagnetic pulses in regards to cell phones, computers, automobile computers wherein the nanoparticles are blended into the materials of interest directly or into the associated materials that render the electromagnetic attenuation protection; item 37) applications of the carbon allotropes or the carbon materials of items 1)-18) and the modified material of items 19)-31) regarding, but not limited to electromagnetic radiation attenuation properties applied, but not limited, to avoidance of electromagnetic radiation echo detection technology as with radar; item 38) applications of the carbon allotropes or the carbon materials of items 1)-18) and the modified material of items 19)-31) regarding emf attenuation/reception applied, but not limited, to microwave oven use as in susceptor pads as in replacement of metal foil alternatives and to radiation-induced warming capability in clothing and/or equipment where especially high solar radiation is available in the midst of frigid temperatures; item 39) applications of the carbon allotropes or the carbon materials of items 1)-18) and the modified material of items 19)-31) regarding emf attenuation/reception applied, but not limited, to enhancement of electromagnetic transmission reception equipment or techniques; item 40) applications of the carbon allotropes or the carbon materials of items 1)-18) and the modified material of items 19)-31) regarding, but not limited, to electromagnetic radiation attenuation/reception properties applied, but not limited, to thermal stimulation in a multitude of ways particularly for use in polymers, plastics, paints, coatings and adhesives or solders for curing purposes by blending the nanoparticles into the materials of interest directly or into the associated materials that render the thermal stimulation properties; item 41) applications of the carbon allotropes or the carbon materials of items 1)-18) and the modified material of items 19)-31) regarding tribology and/or thermal insulation properties applied, but not limited, to motor oils, lubes, cookware, associated coatings by blending the nanoparticles into the materials of interest directly or into the associated materials that render the tribology properties; item 42) applications of the carbon allotropes or the carbon materials of items 1)-18) and the modified material of items 19)-31) regarding hydrophobicity properties applied, but not limited, to water resistance applications as in window and windshield fog elimination, weather-resistant material and clothing, biotechnological and biomedical pursuits, biomaterial encapsulation by blending the nanoparticles into the materials of interest directly or into the associated materials that render water resistant properties; item 43) applications of the carbon allotropes or the carbon materials of items 1)-18) and the modified material of items 19)-31) regarding biotechnological and/or biomedical and/or preventive medicine utilization applied, but not limited, to selective tumor ablation due to radiation attenuation/thermal stimulation properties upon local administration of the nanoparticles followed by the application of highly directed microwave probes, antioxidant or photonic modulation effects for maintenance of living organism damage control effects by oral or injection nanoparticle procedures including use in acupuncture and related therapeutic regimens and also application topically especially on skin disorders including, but not limited to, moles and wounds; item 44) applications of the carbon allotropes or the carbon materials of items 1)-18) and the modified material of items 19)-31) regarding biotechnological and/or biomedical utilization applied, but not limited, to bone scaffolding especially regarding, but not limited, to 3D printing technology, x-ray or MRI contrasting agents, drug or gene delivery, and heavy metal removal; item 45) applications of the carbon allotropes or the carbon materials of items 1)-18) and the modified material of items 19)-31) regarding covetic alloy products produced in numerous manners including during the production of nanocarbon materials; item 46) applications of the carbon allotropes or the carbon materials of items 1)-18) and the modified material of items 19)-31) regarding thermal stability properties for allowing these materials' utilization under high temperature conditions; item 47) applications of the carbon allotropes or the carbon materials of items 1)-18) and the modified material of items 19)-31) regarding thermal stability properties in biological studies where unconverted nanomaterial would survive combustion removal of biological matter for the purposes of tracking delivery of nanocarbon materials in biological systems; item 48) applications of the carbon allotropes or the carbon materials of items 1)-18) and the modified material of items 19)-31) regarding magnetic properties in biological systems as in specifically targeted therapy and bioimagery and other magnetism important applications; and item 49) applications of the carbon allotropes or the carbon materials of items 1)-18) and the modified material of items 19)-31) regarding electromagnetic attenuation properties in regards to energy production especially in regards to solar energy issues.

While the foregoing is directed to embodiments of the present disclosure, other and further embodiments may be devised without departing from the basic scope thereof.

1. A carbon allotrope comprising a multilayered three-dimensional carbon array generally of nanocarbon proportions but not excluding larger arrays beyond the 100 nm nanocarbon limits, wherein stabilizing electron delocalization crosses or proceeds between layers as well as along layers in multiple directions within a continuous cyclic structure with an advanced interlayer connectivity bonding system involving the whole carbon array apart from incidental defects.

2. The carbon allotrope of claim 1, wherein the carbon array is fixed in place in its most thermodynamically stable configuration according to its spheroidal or quasi-spherical confinement.

3. The carbon allotrope of claim 2, wherein the spheroidal or quasi-spherical structure possesses a void or hole central to the overall multilayered carbon array.

4. The carbon allotrope of claim 3, wherein the spheroidal or quasi-spherical structure comprises predominantly long stretches of multilayered planar regions within the carbon array.

5. The carbon allotrope of claim 4, wherein the planar regions are optimally aligned by the spheroidal or quasi-spherical structure for inducing a hopping effect of electrons between layers and thus generating electron delocalization crossing or proceeding between layers.

6. The carbon allotrope of claim 5, wherein the planar regions are optimally aligned according to a graphene stacking arrangement of an “AAAA . . . ” orientation.

7. A carbon comprising allotrope, comprising a multilayered three-dimensional nanocarbon array, wherein stabilizing electron delocalization crosses between layers in an advanced interlayer connectivity bonding system involving the whole carbon array.

8. The carbon comprising allotrope of claim 7, wherein the stabilizing electron delocalization proceeds between layers or surfaces and throughout the whole network of carbons in multiple directions in the carbon comprising allotrope.

9. A carbon material, comprising a multilayered three-dimensional nanocarbon array, wherein stabilizing electron delocalization crosses between layers in an advanced interlayer connectivity bonding system involving the whole nanocarbon array.

10. The carbon material of claim 9, wherein the nanocarbon array is derived from a carbon material of a carbon nano-onion (CNO) precursor.

11. The carbon material of claim 10, wherein the carbon nano-onion (CNO) precursor has consistently an exceptionally low polydispersity regarding onion size.

12. The carbon material of claim 10, wherein the carbon nano-onion (CNO) precursor is devoid of miscellaneous carbon impurities.

13. The carbon material of claim 10, wherein the carbon nano-onion (CNO) precursor is devoid of non-onion nanocarbon materials such as carbon nanotubes (CNTs) and graphene.

14. The carbon material of claim 9, wherein a normally ubiquitous hydrogen atom is not present to any measureable extent even regarding moisture.

15. The carbon material of claim 9, wherein the carbon material from which the nanomaterial is derived has a multilayered generally spherical, spheroidal or quasi-spherical form.

16. The carbon material of claim 9, wherein the multilayered three-dimensional nanocarbon array is produced in oligomerized, polymerized or catenated states with properties thereby enhanced in applications in composites and electrical conductivity.

17. The carbon material of claim 9, wherein heteroatoms or ensembles of heteroatoms like nitrogen, silicon, boron, phosphorous, sulfur and oxygen are incorporated into the framework with minimal disruption of the electron delocalization but with inculcating the nanocarbon material with additional properties related to the nature of the heteroatom(s) incorporated.

18. The carbon material of claim 9, wherein functionalization is applied in a wide variety of known techniques including, but not limited to, 1,3 dipolar additions and other cycloadditions including carbene or nitrene reactions, radical additions, fluoridations or halogenations, alkylations, and redox procedures.

19. The carbon material of claim 9, wherein the carbon material is used in applications regarding material science, metallurgical modifications as with alloy improvements with replacement of traditional carbon components and also covetics, aerospace, solar energy, 3D printing, polymers and plastics, polymer or plastic or inorganic composites or matrices, emf thermoset plastic curing, paints and coatings, oxidation/combustion resistance application, glass treatments, thermal insulation, electronics, electrical transmission, batteries or capacitors, emf attenuation/reception, catalysis, tribology, optical limiting, water resistance, cancer and dermatological treatments, preventive medicine, biological ablation therapy, emf-therapy, radiation protection, radiological contrasting agents including other bioimaging technologies, drug or gene agent delivery, toxin and heavy metal removal, and other biotechnology innovations.

20. The carbon comprising allotrope of claim 7, wherein the carbon comprising allotrope is used in applications regarding metallurgical modifications as with alloy improvements with replacement of traditional carbon components and also covetics, aerospace, solar energy, 3D printing, polymers and plastics, polymer or plastic or inorganic composites or matrices, emf thermoset plastic curing, paints and coatings, oxidation/combustion resistance application, glass treatments, thermal insulation, electronics, electrical transmission, batteries or capacitors, emf attenuation/reception, catalysis, tribology, optical limiting, water resistance, cancer and dermatological treatments, preventive medicine, biological ablation therapy, emf-therapy, radiation protection, radiological contrasting agents including other bioimaging technologies, drug or gene agent delivery, toxin and heavy metal removal, and other biotechnology innovations.
